(19) United States
(12) Patent Application Publication
(10) Pub. No.: US 2005/0202215 A1
(43) Pub. Date: Sep. 15, 2005

(54) Corrugated apparatus having treated edges

(76) Inventors: Donald L. Temple II, Canterbury, NH (US); Michael Mills, Laconia, NH (US)

Correspondence Address: Devine, Millimet & Branch, P.A., 111 Amherst Street, Manchester, NH, 03101, US

(21) Appl. No.: 11/079,603

(22) Filed: Mar. 14, 2005

Related U.S. Application Data
(60) Provisional application No. 60/552,783, filed on Mar. 12, 2004.

(51) Int. Cl. B32B 3/00

(52) U.S. Cl. 428/182; 428/166; 428/188

(57) ABSTRACT

A corrugated apparatus having treated edges. The corrugated apparatus includes a corrugated base having at least one edge and a substance at least partially deposited on at one of the at least one edge of the corrugated base. A corrugated apparatus including at least two corrugated bases, each of the bases having at least one edge and a substance at least partially on the at least one edge of the at least two corrugated bases is also disclosed. A corrugated apparatus including at least two corrugated bases, each of the bases having at least one edge, and a substance at least partially on the at least one edge of the at least two corrugated bases wherein the substance substantially attaches the two corrugated bases is also disclosed.

### CROSS-REFERENCE TO RELATED APPLICATIONS

The present application claims the benefit of Provisional Patent Application Ser. No. 60/552,783 filed Mar. 12, 2004, which is incorporated herein by reference

### TECHNICAL FIELD

The present invention relates to the field of corrugated materials, and in particular to a corrugated apparatus having treated edges.

### BACKGROUND INFORMATION

In the field of forming and utilizing corrugated sheet materials in myriad applications, exposed edges have been treated in many ways to achieve desirable characteristics such as smoothness and resistance to foreign materials entering or escaping the open areas in the material's corrugated structure. Currently, it is common to deform, cover or install concealing components to the edges of corrugated material to create smooth or sealed edges.

Existing methods of deforming the material edge affect the overall material dimensions and are rarely capable of reliably sealing the edges of the material against contaminants. Deformation of the edge also creates variable results and consumes different amounts of base material depending on the corrugation direction relative to the deformed edge and the quantity of material deemed necessary to produce the desired results.

Other methods which resemble the application of tape to the exposed edge rely on adhesives that may degrade over time or as a result of exposure to chemicals or elements present in the environment where the corrugated material or structure is to be used. The durability and life expectancy of an edge or feature treated by this method is heavily determined by the strength and durability of the material applied to the edge and the joining method used.

The use of extraneous or dissimilar materials such as plastic or aluminum extrusions has proven unreliable as interference with other objects or damage to the extraneous component causes it to become insecure or dislodged from the material edge.

Accordingly, there is a need for a method of treating the edges of corrugated materials that results in a durable edge that can be reliably and permanently sealed against the entrance or escape of contaminants into or out of the hollow spaces in the corrugated material.

### SUMMARY OF THE INVENTION

In accordance with one aspect of the present invention, a corrugated apparatus is disclosed. The corrugated apparatus includes a corrugated base having at least one edge and a substance at least partially deposited on at one of the at least one edge of the corrugated base.

Some embodiments of this aspect of the invention include one or more of the following. Where the corrugated base is made of plastic. Where the corrugated base is made of polypropylene. Where the corrugated base is made of polypropylene. Where the substance is polypropylene. Where the substance forms at least one structure on the at least one edge of the base. Where the substance attaches the at least one edge to another of the at least one edge. Where the apparatus further includes an object attached to the corrugated base. Where the corrugated base has an aperture having a predetermined size and shape, the aperture having at least one edge. Where the apparatus further includes where the corrugated base has at least one aperture having a predetermined size and shape, the aperture having at least one edge.

In accordance with another aspect of the present invention, a corrugated apparatus is disclosed. The apparatus includes at least two corrugated bases, each of the bases having at least one edge and a substance at least partially on the at least one edge of the at least two corrugated bases.

Some embodiments of this aspect of the invention include one or more of the following. Where at least one of the at least two corrugated bases is made of plastic. Where the substance is plastic. Where the substance forms at least one structure on the at least one edge of the at least two bases. Where the substance forms a first structure on at least one of a first of the at least two corrugated bases and a second structure on at least one of a second of the at least two corrugated bases, wherein the first structure substantially matably attaches to the second structure. Where the apparatus further includes where at least one of the corrugated bases has at least one aperture having a predetermined size and shape, the aperture having at least one edge.

In accordance with another aspect of the present invention, a corrugated apparatus is disclosed. The apparatus includes at least two corrugated bases, each of the bases having at least one edge, and a substance at least partially on the at least one edge of the at least two corrugated bases wherein the substance substantially attaches the two corrugated bases.

Some embodiments of this aspect of the invention include one or more of the following. Where the substance rigidly attaches the at least two corrugated bases. Where the substance flexibly attaches the at least two corrugated bases. Where the apparatus further includes an object attached to at least one of the corrugated bases. Where the apparatus further includes where at least one of the corrugated bases has at least one aperture having a predetermined size and shape, the aperture having at least one edge.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a partial section view of the corrugated base material sealed according to one embodiment of the present invention;

FIG. 2 is a partial section view of the corrugated base material sealed according to one embodiment of the present invention;

FIG. 3 is a front view of the corrugated base material sealed according to one embodiment of the present invention;

FIG. 4 is a partial section view of the corrugated base material sealed according to one embodiment of the present invention;

FIG. 5 is a partial section view of the corrugated base material sealed according to one embodiment of the present invention;

FIG. 6 is a partial section view of the corrugated base material sealed according to one embodiment of the present invention;

FIG. 7 is a partial section view of the corrugated base material sealed according to one embodiment of the present invention;

FIG. 8A is a partial section view of the corrugated base material sealed according to one embodiment of the present invention;

FIG. 8B is a partial view of two pieces of corrugated base material each having sealed edges configured to mate with the other according to one embodiment of the present invention;

FIG. 8C is a partial view of two pieces of corrugated base material each having sealed edges configured to mate with the other according to one embodiment of the present invention;

FIG. 8D is a partial view of two pieces of corrugated base material each having sealed edges configured to mate with the other according to one embodiment of the present invention;

FIG. 8E is a partial section view of the corrugated base material sealed according to one embodiment of the present invention;

FIG. 8F is a pictorial view of a flat pattern for a foldable box according to one embodiment of the present invention;

FIG. 8G is a is a pictorial view of a flat pattern for a foldable box according to one embodiment of the present invention;

FIG. 9A is a partial section view of two pieces of corrugated base material sealed according to one embodiment of the present invention;

FIG. 9B is a partial section view of two pieces of corrugated base material sealed according to one embodiment of the present invention;

FIG. 9C is a partial section view of two pieces of corrugated base material sealed according to one embodiment of the present invention;

FIG. 9D is a partial section view of two pieces of corrugated base material sealed according to one embodiment of the present invention;

FIG. 10A is a partial section view of two pieces of corrugated base material sealed according to one embodiment of the present invention;

FIG. 10B is a partial section view of two pieces of corrugated base material sealed according to one embodiment of the present invention;

FIG. 10C is a partial section view of two pieces of corrugated base material sealed according to one embodiment of the present invention;

FIG. 10D is a partial section view of two pieces of corrugated base material sealed according to one embodiment of the present invention;

FIG. 11A is a partial section view of the corrugated base material sealed according to one embodiment of the present invention;

FIG. 11B is a partial section view of the corrugated base material sealed according to one embodiment of the present invention;

FIG. 11C is a partial section view of the corrugated base material sealed according to one embodiment of the present invention;

FIG. 11D is a partial section view of the corrugated base material sealed according to one embodiment of the present invention;

FIG. 12 is a partial section view of the corrugated base material sealed according to one embodiment of the present invention;

FIG. 13A is a partial section view of two pieces of intersecting corrugated base material sealed according to one embodiment of the present invention;

FIG. 13B is a partial section view of two pieces of intersecting corrugated base material sealed according to one embodiment of the present invention;

FIG. 14A is a partial section view of objects fastened onto corrugated base material according to one embodiment of the present invention;

FIG. 14B is a partial section view of objects fastened onto corrugated base material according to one embodiment of the present invention;

FIG. 15A is a partial section view of two pieces of corrugated base material sealed according to one embodiment of the present invention;

FIG. 15B is a partial section view of two pieces of corrugated base material sealed according to one embodiment of the present invention;

FIG. 16 is a partial section view of the corrugated base material sealed according to one embodiment of the present invention;

FIG. 17A is a front view of two pieces of corrugated base material sealed according to one embodiment of the present invention; and

FIG. 17B is a front view of two pieces of corrugated base material sealed according to one embodiment of the present invention and forming a hinge.

### DETAILED DESCRIPTION OF THE PREFERRED EMBODIMENTS

The invention described herein is a corrugated base having a substance on at least one edges of the corrugated base. For the purposes of this specification, the term “edge” of “edges” means any surface of a corrugated material, whether the surface has exposed corrugation or whether the surface does not have exposed corrugation. Edges also include the edges created through apertures in the corrugated base. An edge may be 180 degrees, or greater or less than 180 degrees. The substance on at least one edge can impart a number of characteristics to the corrugated base, including, but not limited to: sealing the edge, sealing the inside of the corrugated base from the outside; partial or complete filling of the edge of openings in the corrugated material; aesthetics; strength; usability characteristics such as smoothness or texturing; attaching multiple pieces of corrugated material together; forming hinges; and forming or fastening of utilitarian features on the corrugated base. The substance may be on edges that run parallel, perpendicular, or at an angle relative to the base's corrugation direction. Additionally, the substance may be put on the corrugated base to create radial butt joints, flat butt joints or any type of joining of corrugated bases. Additionally, by placing the substance on at least one corrugated base edge the result can be to insert and seal objects or other materials/gases in the corrugated base. These objects or other materials can be used for reinforcement or altered properties of the corrugated base. These objects and materials include, but are not limited to, gases, liquid, bars, rods, or any other object or material desired.

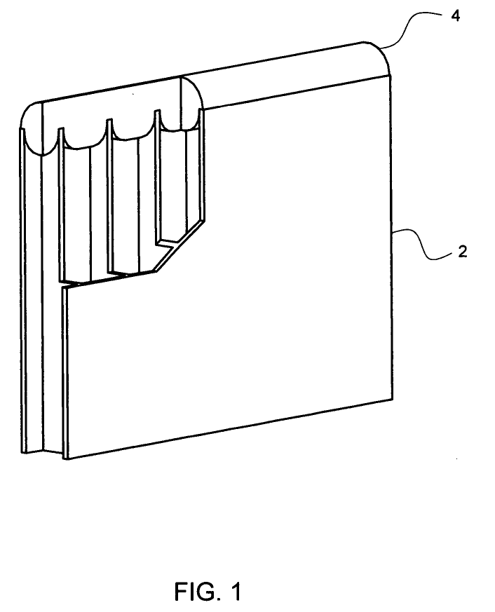

Referring first to FIG. 1, a cut away section of one embodiment of the corrugated apparatus is shown. The corrugated apparatus has a base portion 2 that is a sheet of any corrugated material known in the art. This includes, but is not limited to, corrugated plastic, corrugated cardboard and corrugated steel. The edges of corrugated material generally exhibit some thickness as characterized by a wavy central membrane optionally surrounded by and/or bonded and/or laminated to a substantially flat membrane or membranes of similar or different materials including but not limited to metals, plastics or wood pulp products. In the case of extruded corrugated materials, thickness is generally exhibited by corrugated features rising from a substantially flat surface. Optionally, there may be two or more substantially flat and parallel surfaces joined by multiple ribs resulting in an extruded corrugated structure sometimes referred to in the field as profile extruded corrugated material. Corrugated materials may also be obtained in single sided or multi level configurations, including single face and multi-layer corrugated material.

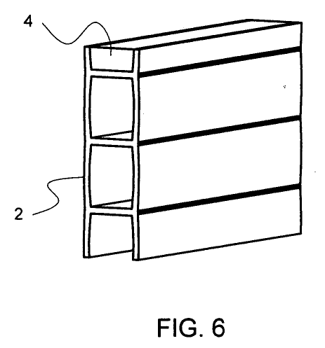

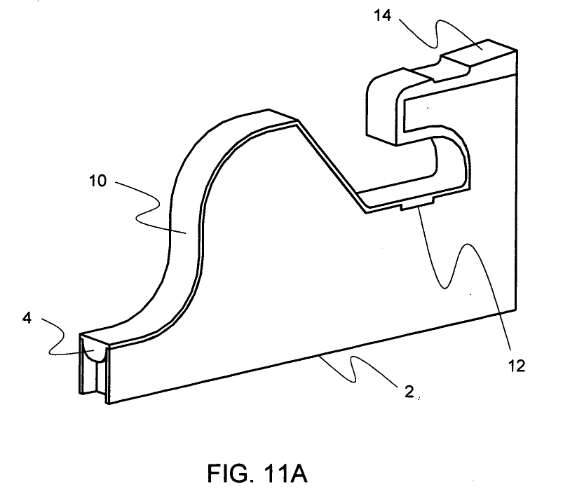

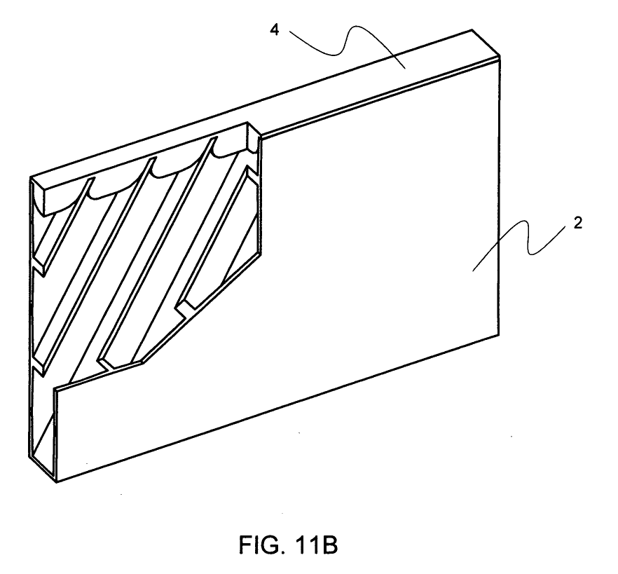

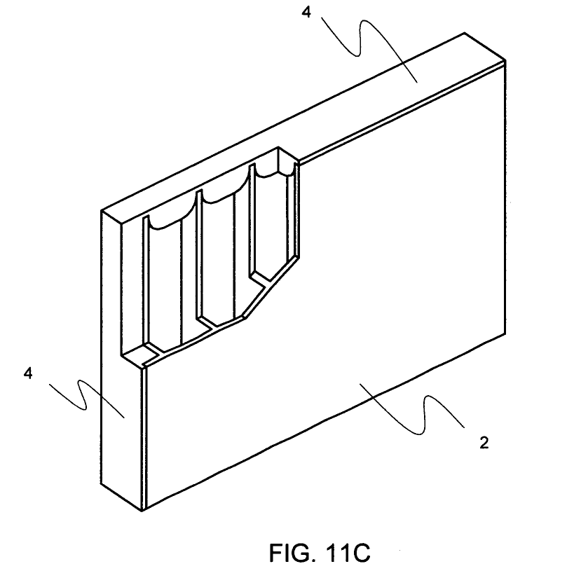

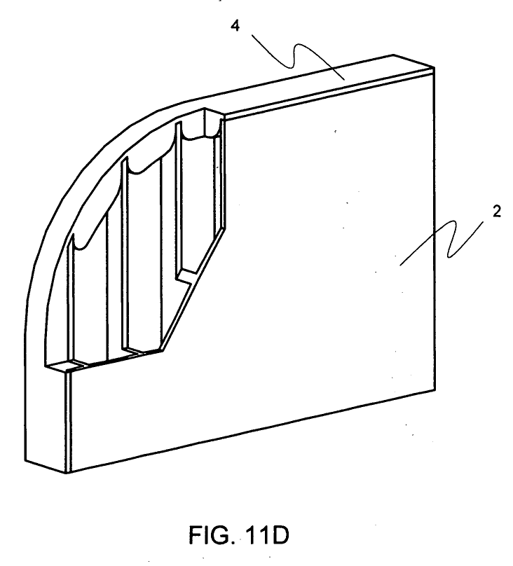

Still referring to FIG. 1, the corrugated base 2 has vertical and parallel wells, running vertical, horizontal or at an arbitrary angle to a reference plane respectively. The present invention can have the substance 4 connected to the base 2 either in the vertical wells, as shown in FIG. 1, or the parallel wells as shown in FIG. 6, or both (as shown in FIG. 11C) or the substance 4 can be connected to edges that cut the corrugation direction at any angle (as shown in FIGS. 11B and 11D).

The corrugated base 2 can be any length, thickness or width. Thus, the corrugated apparatus can be made from a corrugated base 2 having any dimensions. Only a cut away is shown in FIG. 1. The corrugated apparatus includes a substance 4 on at least one edge of the corrugated base 2. As shown in FIG. 1, the substance 4 is connected to the corrugated base 2 on an open well side, or vertical side, of the corrugated base 2. However, the substance 4 could be connected to both open well or vertical sides, and can be connected to the closed well sides, parallel sides of the corrugated base.

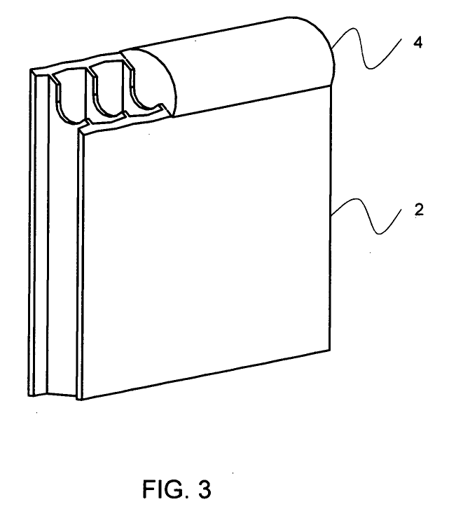

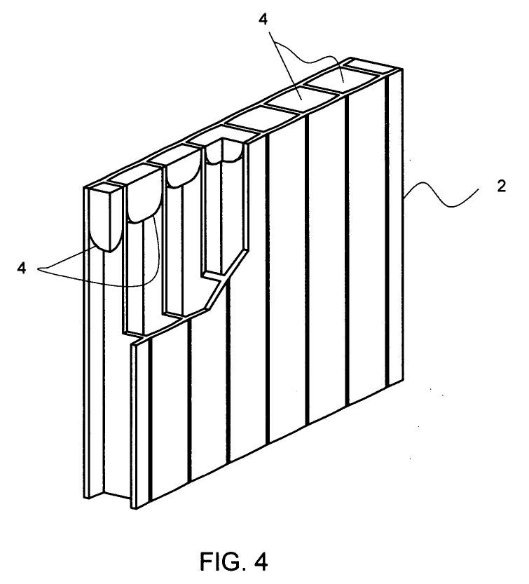

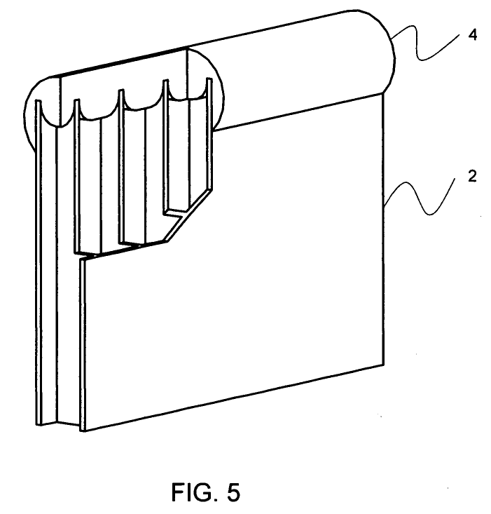

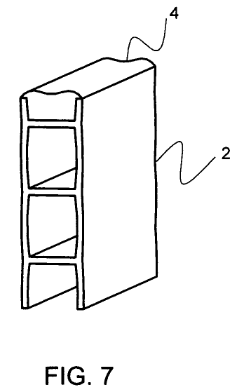

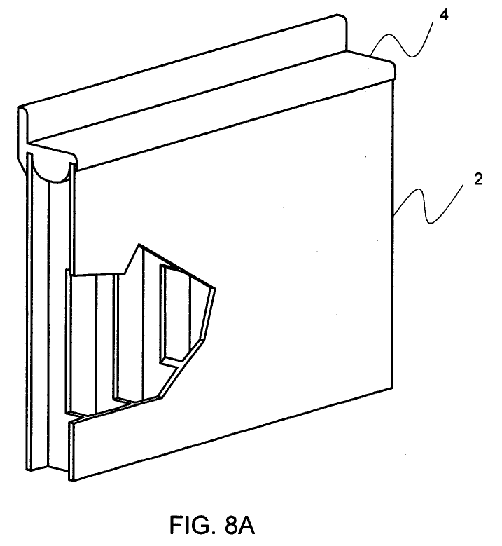

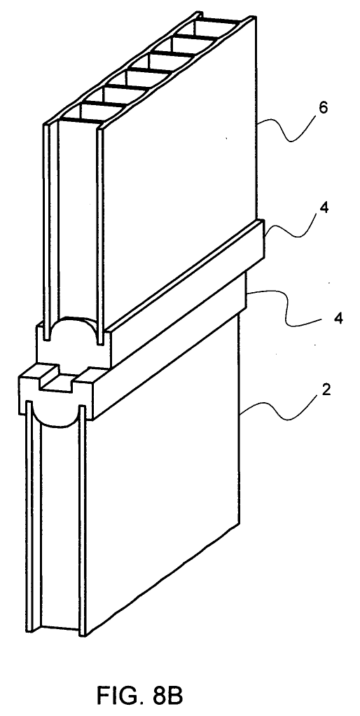

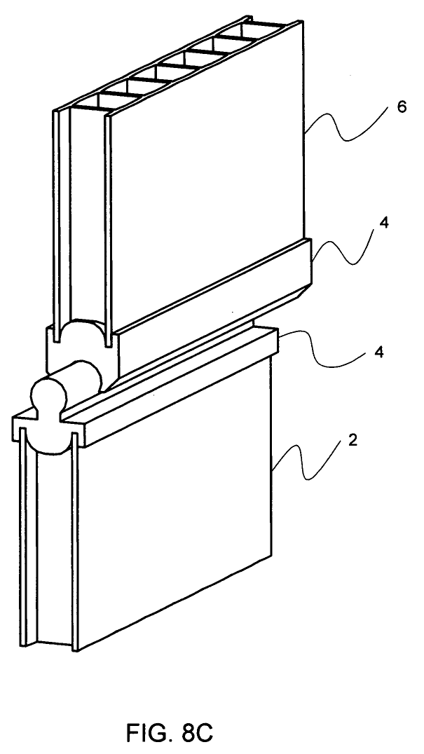

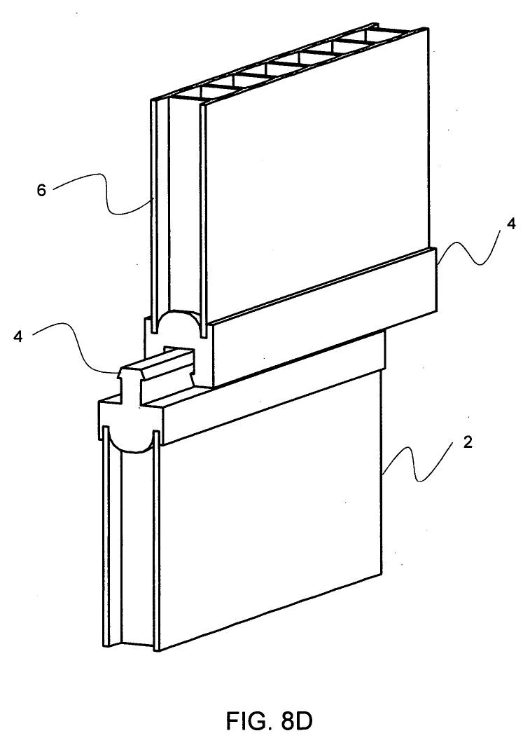

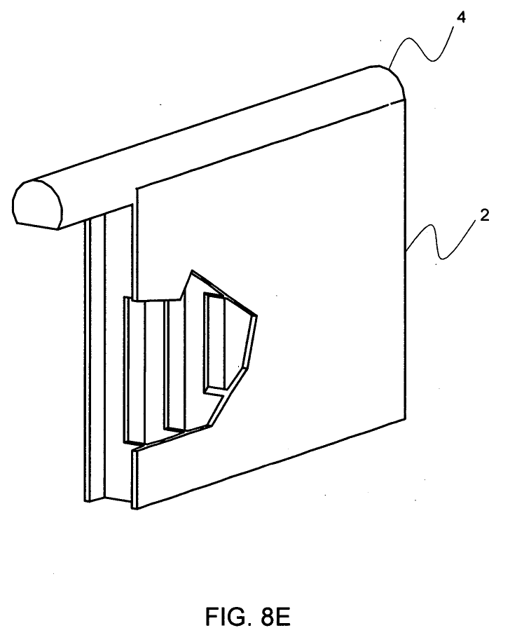

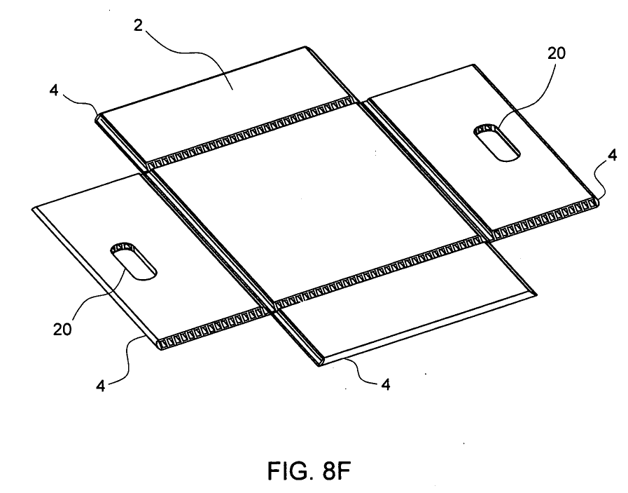

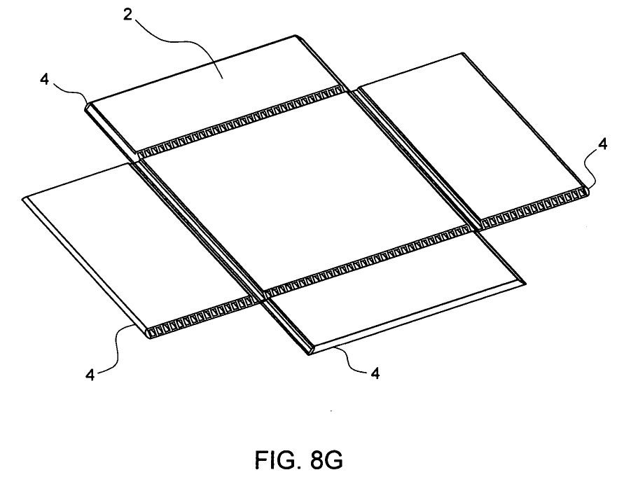

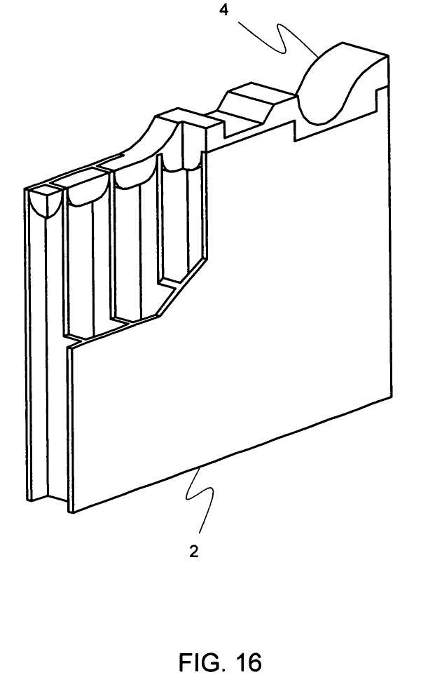

The cut away section shows only sections of two edges of the corrugated base 2. The substance 4 is shown in FIG. 1 to be slightly rounded along the outer edge. The outer edge of the substance 4 forms the actual exposed top area of the corrugated base 2. In other embodiments the substance 4 is flat (as shown in FIG. 4), varying thickness (as shown in FIGS. 11 and 16), more or less curved (as shown in FIGS. 3 and 5) or any other configuration (see FIGS. 7 and 8 for examples), as long as the substance 4 is connected to the corrugated base 2. Additionally, the substance 4 can be deposited to fill the base 2 to varying depths in the wells (as shown in FIG. 4) or to not fill the depths of the wells at all.

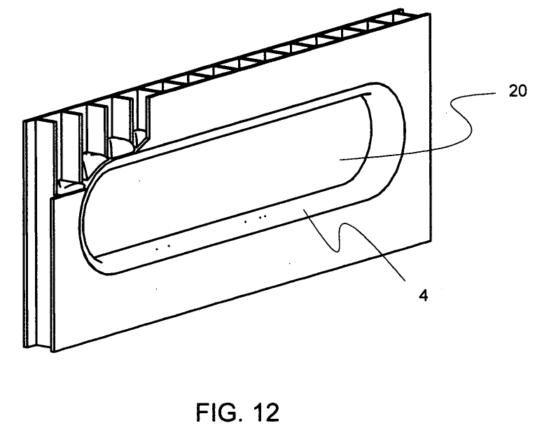

Although in FIG. 1, the substance 4 is depicted as having been deposited over the vertical wells, the substance 4 can be deposited over the parallel wells (as shown in FIG. 6), both the vertical and parallel wells (as shown in FIGS. 11A, 11C, 11D,), over the corner of the edges of the base 2 to form a rounded corner (as shown in FIG. 11D), and within the base material, as shown in FIG. 12. Additionally, as shown in FIG. 11B, the corrugated base 2 can have angled wells, and the substance 4 deposited in the wells along the edge of the base 2.

The substance 4 may be similar to or dissimilar in composition or appearance to the material of the corrugated base 2. In some embodiments, the substance 4 is the same material composition as the base 2. The substance 4 can be made any color and can either match the base 2, contrast, or be different than the base 2. Differing colors, textures or materials may be used to produce desired cosmetic or mechanical properties in the area where the substance 4 is applied. In the preferred embodiment, the substance 4 is any material that can enter into a liquid state, be controllable during deposition and, following, enter a hardened state at room temperature. Additionally, the substance 4 must be able to form and maintain a connection to the base 2, and retain its integrity.

Typical substances 4 that may be deposited include, but are not limited, epoxies, plastics, elastomers, glues or any material that can be controllably deposited on the base material. Typical methods of application include extrusion, pumping, mixing and pumping, or pouring of material controllably onto or into the openings and edges of the corrugated base. Additionally, metals and other elements can be used as the substance 4. Flow and forming of the substance 4 may be controlled by use of extrusion dies, dams or cavities that contain the flow and or shape of the substance 4 over the period of time required for the substance 4 to solidify, cool, or otherwise harden in the final desired form.

The substance 4 is generally characterized by the ability to flow through tooling used to place the substance 4 onto the corrugated base 2 and the ability to solidify once dispensed. The substance 4 may be chemically similar or dissimilar to the corrugated base 2 and can be placed onto the corrugated base 2 by means that melt, dissolve or otherwise affect or interact with the corrugated base 2, but in some embodiments, there is no effect to the corrugated base 2.

In some embodiments, the substance 4 may be composed of virgin or recycled materials and may include fillers or other additives such as wood pulp, fiberglass, plasticizers, coloring agents, UV inhibitors or other additives that produce desirable characteristics in the finished apparatus.

The substance 4 is therefore placed onto at least one edge of the corrugated base 2. As described above, the substance 4 does not have to enter into the wells of the corrugated base 2. In some embodiments, the substance 4 rests on the edge and does not enter into the wells. However, for simplicity in describing the embodiments of this invention, the term “depositing” is used to describe that the substance 4 is placed on the edge of the corrugated base 2, whether or not it enters the wells.

The depositing of the substance 4 may be controlled to achieve consistent or varying thicknesses of substance 4 in different cross sectional configurations. Substance 4 may be pressed into the openings of the corrugated material to produce a flat sealing of the substance 4 edge (as shown in FIGS. 4 and 6) or the substance 4 may protrude above the original edge of the base 2 to produce such characteristics as rounded or specially contoured edges or features (as shown in FIGS. 1, 2, 3, 5, 7 and 8) or both of these. The substance 4 may extend beyond the thickness of the base 2 to provide desirable strength or utility characteristics. Therefore, the substance 4 can extend as deeply as desired into the base 2 wells, and can extend above the base 2 to any thickness or formation. Also, the substance 4 can rest on the edge and not enter the wells. As well, any combination of these are contemplated as alternate embodiments.

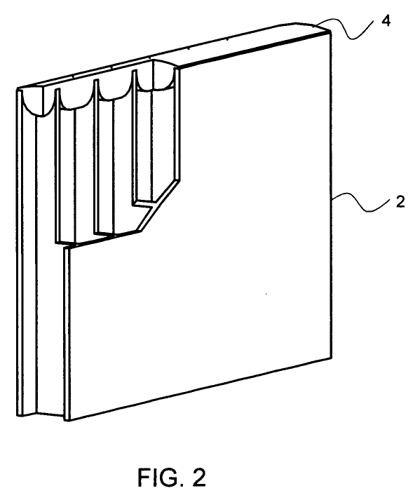

Referring again to FIG. 1, the corrugated base 2 is shown with the substance 4 deposited along one edge. In this embodiment, the substance 4 is deposited so it is slightly rounded over the top edge. Referring now to FIG. 2, in some embodiments, the substance 4 may be applied to achieve any desired profile on the base 2 edge. Referring now to FIG. 3, another alternate embodiment is shown where the substance 4 is applied on the edge of the base 2 in any arbitrary angle relative to the other faces of the base 2. The degree of angle can be any degree desired. Additionally the base 2 may have additional treatment or forming on the subject edge prior to application of additional substance 4 as shown in FIG. 3. Referring now to FIG. 4, the substance 4 is deposited flush to the base 2. As shown in this figure, the substance 4 can be deposited to varying depths in the wells. Referring now to FIG. 5, an alternate embodiment is shown where the substance 4 is deposited to extend beyond the width of the base 2.

Referring now to FIG. 6, the embodiment where the substance 4 is deposited into the horizontal or parallel wells is shown. The substance 4 is deposited in the parallel corrugation direction of the base 2. Additionally, in some embodiments, the substance 4 is deposited to be flush with the edge of the base 2. Although in this embodiment, the substance 4 is flush with the parallel wells of the base 2, in other embodiments, the substance 4 is deposited flush with the vertical wells, or to both the vertical and parallel wells or generally flush to the base 2 edge when wells are at an angle to the edge.

Referring now to FIG. 7, the substance 4 is applied with an arbitrary contour on the edge of the base 2. This embodiment also shows the corrugation in the parallel direction. In other embodiments, the arbitrary contour of the substance 4 is deposited onto the edge of the base 2 either with the corrugation in the vertical direction or oriented at another arbitrary angle relative to the edge.

The substance 4, in some embodiments, seals the inside of the corrugated base 2. In some cases, the seal created by the substance 4 is airtight. In other embodiments, the substance 4 does not fully seal the corrugated base 2. Additionally, for the corrugated base 2 to be airtight, all open well flutes of the corrugated base 2 must be sealed.

Referring next to FIG. 8A, one embodiment of the substance 4 is shown applied in such a manner that it serves a utilitarian purpose beyond sealing the edge of the base 2. The substance 4 is applied such that it forms a structure. In this example, a lip is formed. This lip is utilitarian for stacking containers made from the corrugated base material. The lip can provide many other functions, including, without limit, sealing the top of a container made from the invention as shown. The dimensions of the lip can be any dimensions desired. FIGS. 8B, 8C and 8D depict additional utilitarian forms that may be achieved by this method. These examples shown have the added feature of mating with parts that have complimentary features. The corrugated bases 2, 6 have complementary structures formed from the substance 4 that allow the two corrugated bases 2, 6 to substantially mate and attach to one another. These attachments can be releasable or permanent. Referring to FIG. 8E, added substance 4 may also extend beyond the length of the base 2 to be used for cosmetic or functional purposes. As is evident from these FIGS., the substance 4 can form structures of any size or shape on any edge of the corrugated base 2.

Referring now to FIGS. 8F and 8G, two pictoral views of the invention in practice are shown. These are only two embodiments of the invention and are shown for illustration purposes, the invention is not limited to these two embodiments. Here, the corrugated base 2 includes scoring and cutouts. The corrugated base 2 includes substance 4 deposited about the outside edges of the base 2. The inside edges are open wells that do not include substance. Referring to FIG. 8F only, the corrugated base 2 can also include apertures 20. The apertures can either have the substance applied about the aperture edges or not. As shown in FIG. 8F, the apertures 20 do not have substance deposited. Referring to FIG. 8G only, in this embodiment, the corrugated base 2 does not include apertures.

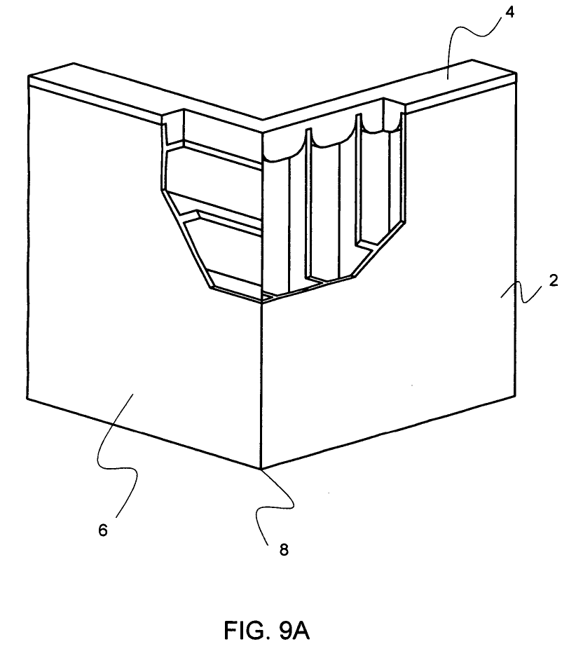

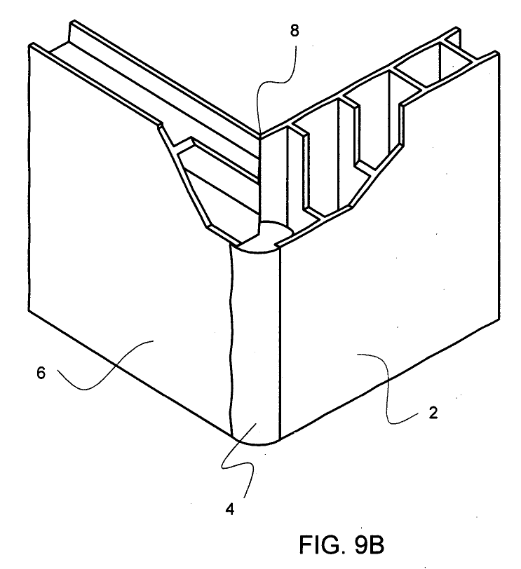

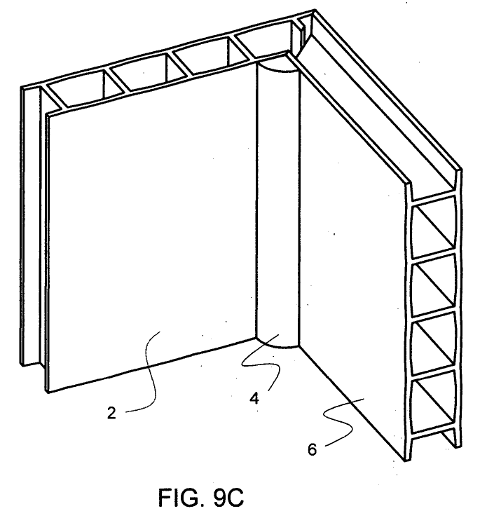

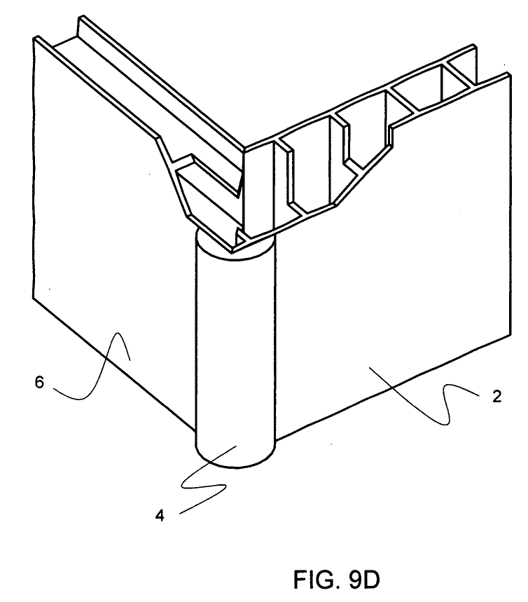

Referring now to FIGS. 9A-9D, partial views are shown where the substance 4 is applied to two pieces of base 2,6. The two pieces of base 2, 6 may or may not have been joined by other means. The two bases 2,6 may be of similar or dissimilar compounds and may have their corrugated features orientated in the same or different directions. For illustration purposes only, the bases 2, 6 are shown oriented in different directions. The substance 4, in some embodiments, acts to attach the two bases 2,6 together. For illustration purposes only, the embodiments shown are partial views and include only two bases. However, in other embodiments, two of more bases are involved. The description that follows, taken together with the drawings, exemplify the different features that these embodiments can posses. However, the different features can be “mixed and matched” to form embodiments having one or more of the following features. Additionally, these figures only show partial views, and more than two bases are used in other embodiments of the present invention.

Referring now to FIG. 9A, the substance 4 acts to both seal the edges of the bases 2,6 and can also serve as the only attaching means to attach base 2 to base 6. In FIG. 9A, the edges of bases 2,6 come together directly to form a joint 8. In some embodiments, joint 8 is formed by melting or bonding the edges of the bases 2,6 together. In other embodiments, joint 8 is formed by the bases 2,6 coming together, but are not attached by other means at joint 8.

Referring next to 9B, the bases 2,6 are held together entirely by substance 4. Here, the substance 4 is deposited along the edges of the base 2,6 that face one another. In some embodiments, additional adhesive means, including heat for melting, are applied to the point where bases 2,6 come together. Adhesive means, as used herein, refers to any method or compound for connecting two corrugated bases known in the art, including the application of heat to melt the base material.

The corner is formed by relieving the bases 2,6 so that substance 4 may be flush with bases 2,6. As depicted in this embodiment, the substance 4 forms a radius, but this is only one embodiment, in other embodiments, the substance 4 can form any geometric shape desired, including, without limit, a notch or chamfer. Additionally, although in this embodiment, the substance 4 is not deposited along the top edges of the bases 2,6, the substance 4 is deposited along the side edges. In other embodiments, substance is deposited along any or all of the edges of bases 2,6.

Referring now to FIG. 9C, the bases 2,6 are held together by substance 4 deposited at the meeting point between the bases 2,6. In some embodiments, the bases 2,6 are additionally held together by other adhesive means including melting. In still other embodiments, the substance is also deposited along the top edges of the bases (as shown in FIG. 9A). The bases 2,6 are cut away so as to come together flush. Although as shown in this figure, the substance 4 is a radius, in other embodiments, the substance 4 can form any geometry.

Referring now to FIG. 9D, the bases 2,6 come together and substance 4 is added on to the outside of the apparatus formed. The substance 4 rises above the bases 2,6. The substance 4 is added to have the effect of smoothing or softening the corner formed by the two bases 2,6. The substance 4 in this figure is a radius, but in other embodiments, the material 4 forms any geometry. In some embodiments, the bases 2,6 are additionally held together by other adhesive means including melting. In still other embodiments, the substance is also deposited along the top edges of the bases (as shown in FIG. 9A).

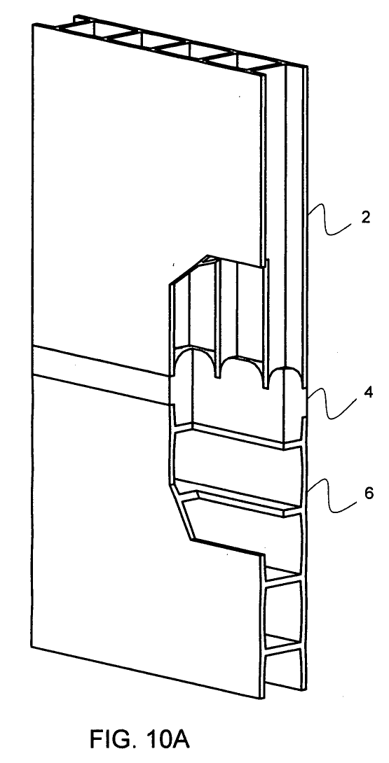

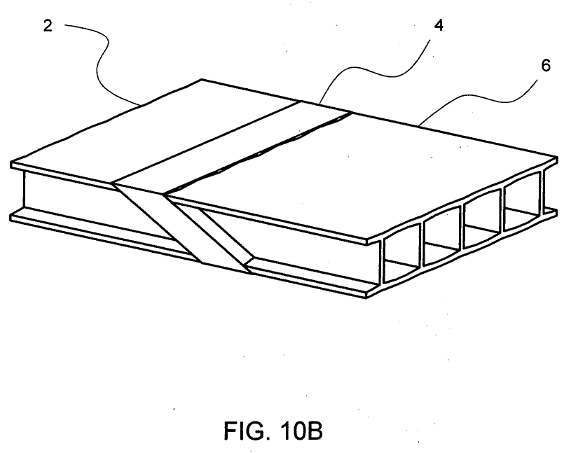

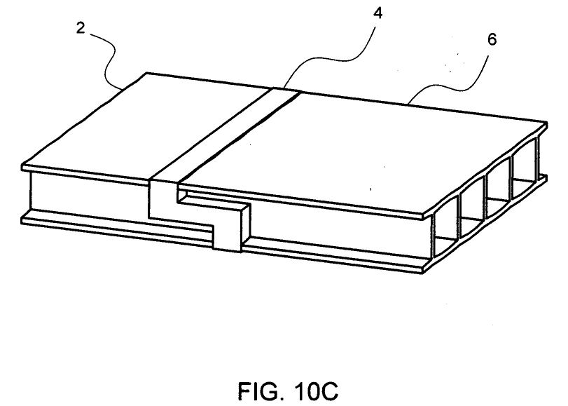

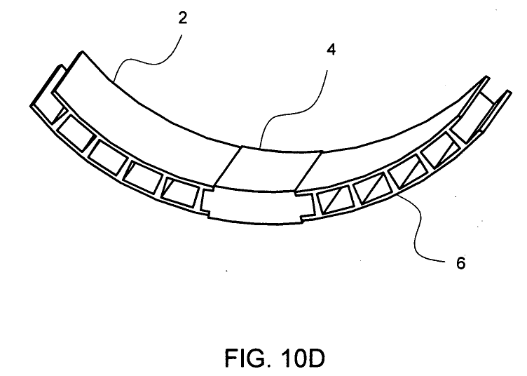

Referring next to FIGS. 10A-10B, multiple embodiments are shown depicting two bases 2,6, joined together by substance 4 being deposited at least on the edge that the two bases 2,6 meet. The bases 2,6 are shown as having different corrugation orientations, but in some embodiments, the bases 2,6 have the same orientation, either both parallel or both vertical, or the bases 2,6 may have the same or different edge angles. The joint, formed by the material 4, may be configured to form a flat, angled or radial connection between the two bases 2,6. In other embodiments, other edges of the bases 2,6 also include deposited substance 4.

Referring next to FIGS. 11A-11D, the base 2 may have various features which may be treated with the substance 4. Referring first to FIG. 11A, this base 2 serves as an illustration of the different embodiments of the present invention. The substance 4 may be applied with uniform thickness to match the features of the base 2, as in the area 10. The substance 4 may smooth features of the base 2 as depicted in the area 12. Additionally, the substance 4 may have varying thicknesses as depicted in the area 14.

Referring next to FIGS. 11B-11D, the base 2 can have the substance 4 deposited onto the top edge(s), the side edge(s), or both. Additionally, the base 2 corrugations can be in any orientation. Referring now to FIG. 11B, the base 2 is shown with angled corrugation orientation with substance 4 deposited on an edge. In FIG. 11C, the base 2 is shown with vertical corrugation orientation with substance 4 deposited along both the top and side edges, thus substance 4 is deposited on the parallel and vertical wells. Referring next to FIG. 11D, the base 2 having vertical corrugation orientation includes substance 4 deposited on both the top edge and the side edge. In addition, the base 2 is cut away to form a rounded edge, and the substance 4 is deposited along the rounded edge to create a smooth, seamless edge.

Referring next to FIG. 12, an alternate embodiment of the present invention is shown. In some embodiments of the invention, the corrugated base 2 includes at least one internal feature/aperture 20. The substance 4 can be deposited onto internal features/apertures 20 of the base 2. Any internal features/apertures 20 are included in this embodiment and the one shown is for illustration purposes only. As with all embodiments of the present invention, the thickness, contour, color or composition of the substance 4 may be varied to achieve the function or aesthetic characteristics desired. Additionally, although the orientation of the corrugation of the base 2 is shown to be vertical, in other embodiments, the orientation varies, including angled and parallel. Also, in other embodiments, the substance 4 is additionally deposited onto at least one additional edge of the base 2.

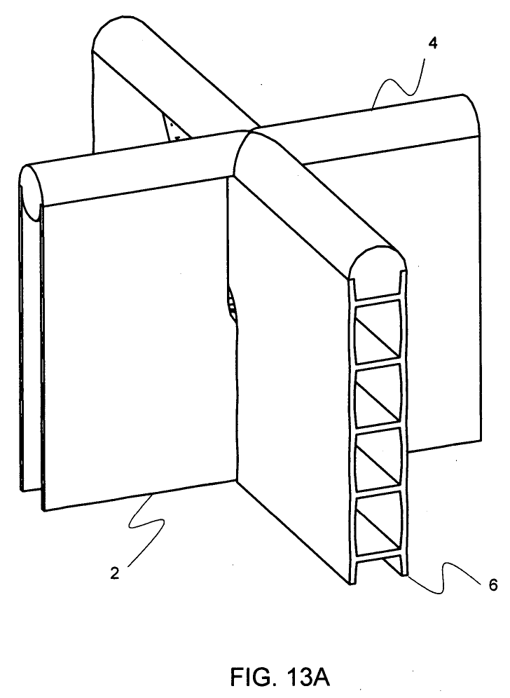

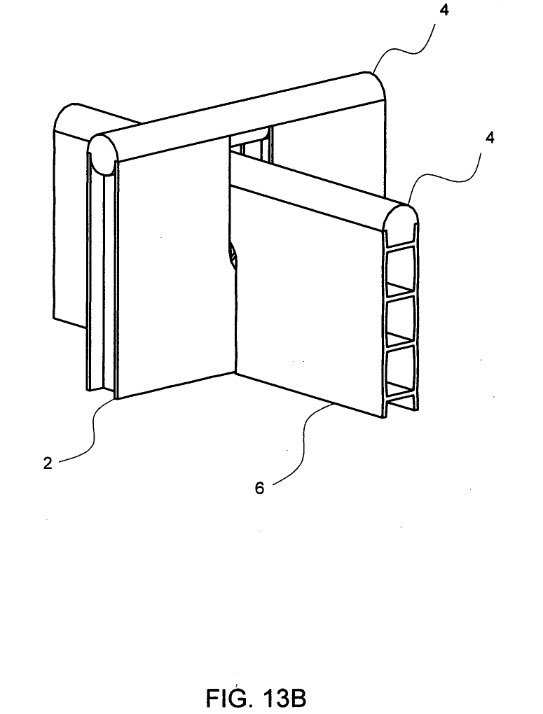

Referring next to FIG. 13A, substance 4 is deposited upon two intersecting bases 2,6, which are either joined by a joining or adhesive means, or not joined by a joining or adhesive means. The bases 2,6 can share the same corrugation orientation, or be different with respect to their corrugated features. The bases 2, 6 may be oriented at any angle relative to each other and are not restricted to the perpendicular illustration shown in FIG. 13. Substance 4 is deposited in the top edge of the bases 2,6, but additionally, can be deposited along the side edges or around the corners, or any other embodiment described herein. As shown in FIG. 13B intersecting parts may be spaced such that the added material 4 does not bond the bases 2,6 and may allow angular or linear movement between the bases after the material 4 has been applied.

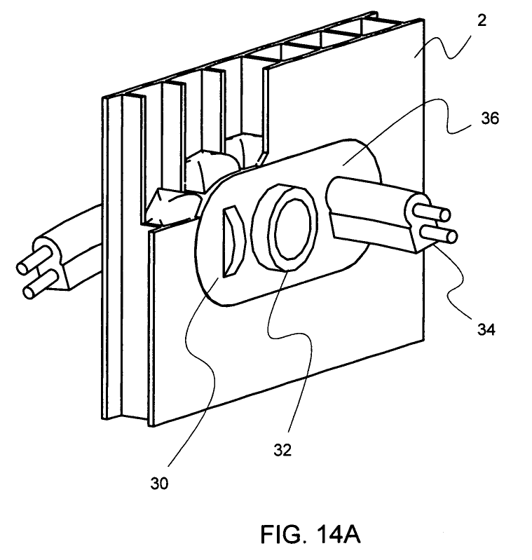

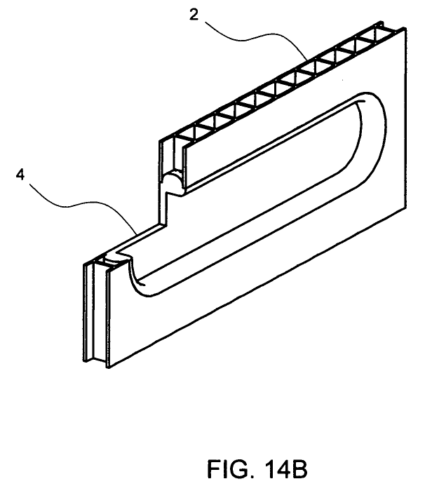

Referring next to FIG. 14A, various objects 30, 32, 34 are fastened to the base 2 with substance 4. Items 30 and 32 may be separately fabricated components held in place by substance or by any other means. Alternatively, items 30 and 32 may be integral features of item 36, formed by the cavity halves and material utilized to create item 36. Object 32, in one embodiment, is a grommet, but in other embodiments could be any object. Object 34 in one embodiment is a wire, and object 30 is an arbitrary bump. Item 36 is a volume of material that fills the void in the base 2. These objects and shapes shown and described are for illustration purposes only, and other object and shapes may be used as well.

Referring now to FIG. 14B, the substance 4 can be applied such that a thin wall of substance 4 is created to partially or completely closes an aperture in the base 2. The aperture can be any size or shape and is shown here merely for illustration of one embodiment.

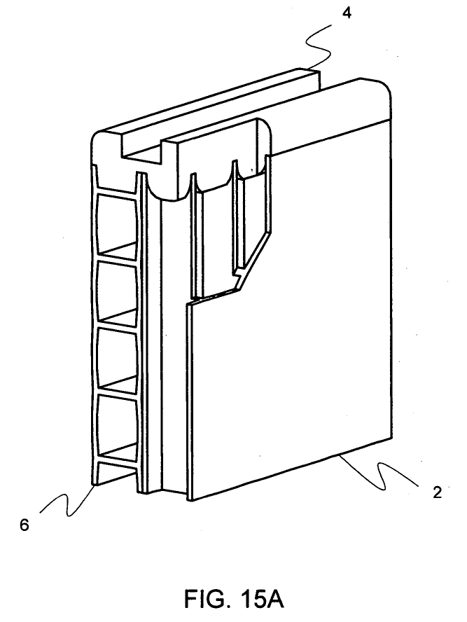

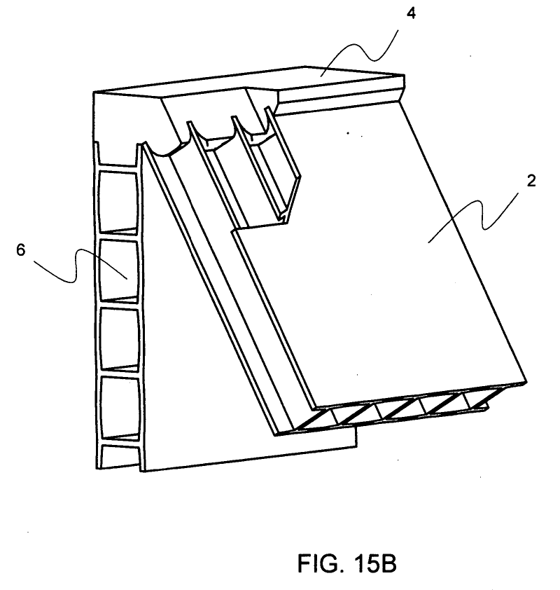

Referring next to FIG. 15A, two bases 2,6 at an arbitrary orientation one to another, are joined together with substance 4. Substance 4 is deposited in such a way as to join both bases 2,6. The substance 4 can be deposited in any way that joins the bases 2,6 including forming any geometry. The bases 2,6 may/may not have been joined by other means in addition. Arbitrary orientation means that the direction of the corrugation in either base 2,6 is arbitrary and the bases 2,6 can maintain different directions, or the same directions. The substance 4 joins the bases 2,6 rigidly.

Referring next to FIG. 15B, another embodiment of the apparatus described in FIG. 15A is shown. In this embodiment, the bases 2,6 are joined together by substance 4, but are joined in such a way that the bases 2,6 are not flush against one another. Again, the bases 2,6, are rigidly joined.

Referring now to FIG. 16, in varying embodiments of the invention, the base 2 can have the substance 4 deposited onto at least one edge having varying thicknesses and forms relative to the base 2.

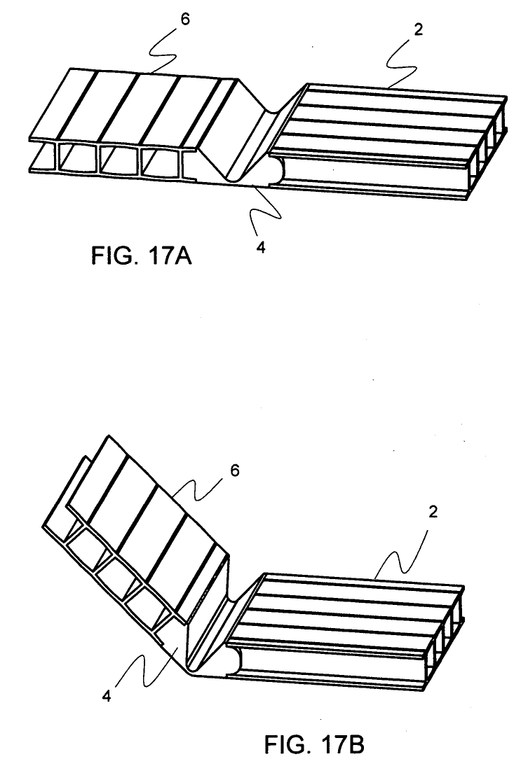

Referring next to FIGS. 17A and 17B, two pieces of base material 2,6 are joined together with substance 4. In FIG. 17A, the bases 2,6 are open, and in FIG. 17B one base 4 is moving towards the other base 2. This exemplifies one embodiment of the substance, where the substance 4 parlays a hinging effect. This is an example of an embodiment where the bases 2,6, are flexibly joined by the substance 4. In FIG. 17B, either base 2,6 can move towards or away from the other, and the bases 2,6 can be in any orientation, and can be either that same or different, with respect to one another. Here, the flexibility is imparted by a thinner section of substance 4 where the hinge is created or by selection of a substance 4 with the desired flexural properties. However, other embodiments include where the substance 4 forms a difference geometry imparting flexibility.

### EXAMPLE

In one example, representing an exemplary embodiment of the present invention for illustration purposes, commodity grade polypropylene is used as both the material and the corrugated base. As described above, any material can be used as the corrugated base and the substance, and these materials can be either the same or difference. In some embodiments, both the base and the substance are a plastic.

The polypropylene corrugated base may be provided with shear cut or mildly burred edges, free of excessive dirt or oils. The base may be room temperature or preheated to a temperature that is not sufficient to weaken the base to the point where handling becomes difficult. For polypropylene of one grade, this temperature is approximately 150 degrees Celsius or until the material deforms. Virgin or recycled polypropylene is introduced to a heating and propelling system such as an extruder. The heating and propelling system/extruder liquefies and forces the substance through the dispensing hole and onto the base material. The substance is dispensed at a temperature of between 180-235 degrees Celsius and cools to hold the desired form imparted on it by the dispensing head and base material. The heating and propelling system/extruder can apply the substance to the base at any configuration, depth, dimension, etc., desired.

Since various grades of polypropylene may be used for this embodiment, different grades of polypropylene will exhibit different thermal properties and therefore, the melting points and temperature in which the phase changes from liquid to solid occurs will vary. One of ordinary skill in the art of the plastic (or other material) being used will understand that the temperature will vary with the compound used.

For all the above-disclosed embodiments the following applies. On dispensing, the substance 4 may flow into the open areas of the corrugated base and the dispensing method or characteristics of the substance 4 may be manipulated to achieve varying degrees of flow into said openings to achieve new and desirable properties not inherent in the corrugated base. Alternatively, the flow of the substance 4 into the openings of the corrugated base 2 may be controlled by manipulating the dispensing method and characteristics of the newly deposited substance 4.

The substance may be added to the edges or openings of more than one base sheet simultaneously to achieve a variety of desirable results. Where multiple base sheets are laminated, common edges and or openings may have substance deposited on them to present the appearance of one smooth or duly formed edge. Where base sheets must be joined end to end, substance may be deposited between the edges to bridge a gap between the given edges. The cross section of the substance deposited between two or more pieces of corrugated base may be varied to produce desirable rigidity or flexibility between the multiple pieces to produce such effects as hinges, springs, or rigid connection. These methods may be utilized regardless of the relative orientation of the multiple bases' corrugation directions.

The deposition of the material may also serve to attach other components to the corrugated material such as fasteners, grommets, electrical contacts, handles, latches, or other pieces of corrugated material. The items attached by this method may be of similar or dissimilar composition relative to the base material, the deposited material or both.

While figures have been shown to provide illustrations of embodiments of the invention, the exact places where the corrugated base is cut, the number of corrugated bases involved or the level and shape of the substance or apertures, for example, is for illustration purposes only.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A corrugated apparatus comprising:
a corrugated base having at least one edge; and
a substance at least partially deposited on at one of said at least one edge of said corrugated base.

2. The apparatus of claim 1 wherein said corrugated base is made of plastic.

3. The apparatus of claim 1 wherein said substance is plastic.

4. The apparatus of claim 1 wherein said corrugated base is made of polypropylene.

5. The apparatus of claim 1 wherein said substance is polypropylene.

6. The apparatus of claim 1 wherein said substance forms at least one structure on said at least one edge of said base.

7. The apparatus of claim 1 wherein said substance attaches said at least one edge to another of said at least one edge.

8. The apparatus of claim 1 further comprising an object attached to said corrugated base.

9. The apparatus of claim 1 further comprising wherein said corrugated base having at least one aperture having a predetermined size and shape, said aperture having at least one edge.

10. A corrugated apparatus comprising:
at least two corrugated bases, each of said bases having at least one edge; and
a substance at least partially on said at least one edge of said at least two corrugated bases.

11. The apparatus of claim 10 wherein at least one of said at least two corrugated bases is made of plastic.

12. The apparatus of claim 10 wherein said substance is plastic.

13. The apparatus of claim 10 wherein said substance forms at least one structure on said at least one edge of said at least two bases.

14. The apparatus of claim 10 wherein said substance forms a first structure on at least one of a first of said at least two corrugated bases and a second structure on at least one of a second of said at least two corrugated bases, wherein said first structure substantially matably attaches to said second structure.

15. The apparatus of claim 10 further comprising wherein at least one of said corrugated bases having at least one aperture having a predetermined size and shape, said aperture having at least one edge.

16. A corrugated apparatus comprising:
at least two corrugated bases, each of said bases having at least one edge; and
a substance at least partially on said at least one edge of said at least two corrugated bases wherein said substance substantially attaches said two corrugated bases.

17. The apparatus of claim 16 wherein said substance rigidly attaches said at least two corrugated bases.

18. The apparatus of claim 15 wherein said substance flexibly attaches said at least two corrugated bases.

19. The apparatus of claim 16 further comprising an object attached to at least one of said corrugated bases.

20. The apparatus of claim 16 further comprising wherein at least one of said corrugated bases having at least one aperture having a predetermined size and shape, said aperture having at least one edge.
